(19) United States
(12) Patent Application Publication
(10) Pub. No.: US 2014/0281232 A1
(43) Pub. Date: Sep. 18, 2014

(54) System and Method for Capturing Behaviour Information from a Program and Inserting Software Prefetch Instructions

(71) Applicant: Hagersten Optimization AB, Uppsala (SE)

(72) Inventors: Ernst Erik Hagersten, Uppsala (SE); Muneeb Anwar Khan, Uppsala (SE)

(73) Assignee: Hagersten Optimization AB, Uppsala (SE)

(21) Appl. No.: 14/211,918

(22) Filed: Mar. 14, 2014

Related U.S. Application Data
(60) Provisional application No. 61/782,925, filed on Mar. 14, 2013.

(51) Int. Cl. G06F 12/08

(52) U.S. Cl. CPC G06F 12/0862
USPC 711/119; 711/137

(57) ABSTRACT

Methods, systems and software for inserting prefetches into software applications or programs are described. A baseline program is analyzed to identify target instructions for which prefetching may be beneficial using various pattern analyses. Optionally, a cost/benefit analysis can be performed to determine if it is worthwhile to insert prefetches for the target instructions.

### RELATED APPLICATION

The present application is related to, and claims priority from U.S. Provisional Patent Application No. 61/782,925, filed Mar. 14, 2013, entitled “SYSTEM AND METHOD OF CAPTURING BEHAVIOUR INFORMATION FROM A PROGRAM AND INSERTING EFFICIENT SOFTWARE PREFETCH INSTRUCTIONS,” to Ernst Erik Hagersten and Muneeb Anwar Khan, the disclosure of which is incorporated herein by reference.

### TECHNICAL FIELD

Embodiments of the subject matter disclosed herein generally relate to software programs and, more particularly, to software prefetching.

### BACKGROUND

Today's processors are often equipped with caches that can store copies of the data and instructions stored in some high-capacity memory. A popular example today of such high-capacity memory is dynamic RAM, or DRAM for short. From here on, the term DRAM will be used to collectively refer to all existing and future high-capacity memory implementations. Cache memories, or caches for short, are typically built from much smaller and much faster memory than DRAM and can subsequently only hold copies of a fraction of the data stored in DRAM at any given time. A processor can request data stored in the DRAM by issuing instructions known as memory instructions. Memory instructions include, but are not limited to, load instructions, store instructions and atomic instructions.

Whenever a processor requests data that is present in the cache, an occurrence referred to as a cache hit, that request can be serviced much faster than an access to data that is not present in the cache, referred to as a cache miss. Typically, a version of an application that experiences fewer cache misses will execute faster than a version that suffers from more cache misses, assuming that the two versions otherwise have similar properties. Therefore, considerable efforts have gone into finding ways to avoid cache misses. Typically, data is installed into caches in fixed chunks that are larger than the word size of a processor, known as cachelines. Common cacheline sizes today are, for example, 32, 64 and 128 bytes, but both larger and smaller cacheline sizes exist for various cache implementations. The cacheline size may also be variable for some cache implementations.

A common way to organize the data placement in a cache is such that each data word is statically mapped to reside in one specific cacheline. Each cache typically has an index function that identifies a portion of the cache where each cacheline can reside, known as a set. The set may contain space to hold one or more cachelines at the same time. The number of cachelines the set can hold is referred to as its associativity. Often, the associativity for all the sets in a cache is the same. The associativity may also vary between the sets. There are also cache proposals where there may be several index functions for a cache, including, but not limited to skewed caches, elbow cache and the Z-cache.

Often, each cache has built-in strategies for what data to keep in the set and what data to evict to make space for new data being brought into the set, referred to as its replacement policy. Popular replacement policies include, but are not limited to, least-recently used (LRU), pseudo-LRU and random replacement policies. Caches are used to store data values (referred to as data caches), to store instructions (referred to as instruction caches) or both data and instructions (referred to as unified caches). Unless specifically stated otherwise, the usage of the word “cache” in this description refers to a data cache and/or a unified cache.

Often, the memory system of a computer system is implemented by a hierarchy of caches, with larger and slower caches close to the DRAM and smaller and faster caches closer to the processor, referred to as cache hierarchy. Each level in the cache hierarchy is referred to as a cache level. Modern processors often have separate level 1 instruction and level 1 data caches and the higher level caches are unified. So-called inclusive cache hierarchies require that a copy of a data (for example a cacheline) present in one cache level, for example in the L1 cache, also exists in the higher cache levels, for example in the L2 and L3 cache. Exclusive cache hierarchies only have one copy of the data (for example a cacheline) existing in the entire cache hierarchy, while non-inclusive hierarchies can have a mixture of both strategies. In exclusive and non-inclusive cache hierarchies, it is common that a cacheline gets installed in the next higher cache level upon eviction from a specific cache level. An example of such a cache hierarchy is illustrated in FIG. 1.

Some architectures have special instructions that can steer the placement of data in the cache hierarchy, referred to as placement-conscious instructions. For example, there are some so-called non-temporal instructions that tell the cache hierarchy to install a cacheline in the L1 cache upon a cache miss, but to not install the cacheline in the next higher cache level upon eviction from the L1 cache in an exclusive or non-inclusive cache hierarchy. There are also other kinds of instructions that can explicitly tell the cache hierarchy to store a cacheline in a way that makes it more likely to be replaced from one specific level of the cache hierarchy. Many other kinds of placement-conscious instructions exist, including but not limited to, instructions specifying a specific cache level to install a piece of data upon eviction.

One way to limit the number of cache misses is to anticipate what data will be requested by the processor in the near future and to bring that data into the cache prior to its usage. This is referred to as prefetching. Some processors have prefetching algorithms implemented in hardware. Such hardware-based prefetching algorithms may dynamically detect some repeated access patterns, such as accesses to data address with an increasing, or decreasing, constant stride, such as an access to the address A, followed by an access to A+4, followed by an access to A+8 and so on. Once such a so-called strided access pattern has been detected, the hardware prefetcher may anticipate the next access in the access pattern and prefetch A+12 into the cache before it is requested and thus turning it into a cache hit.

Many other hardware-based prefetch strategies exist including, but not limited to, adjacent prefetching and prefetching algorithms involving the addresses of the instructions accessing the data for finding strided accesses. Many applications also have irregular access patterns that miss often in the cache but that do not have strided access patterns. These are typically not handled well by existing commercial hardware prefetching implementations.

Processors also typically have special prefetch instructions that allow the application itself to control which pieces of data that should get prefetched from the higher-level caches or the high-capacity memory. Such prefetch instructions can for example be inserted by the programmer, the compiler, the JIT runtime system, some runtime daemon or some other means of changing the stream of instructions to be executed. Prefetch instructions may be placement-conscious instructions.

However, there is a cost/benefit relationship associated with prefetching. The benefit is that a correctly anticipated and prefetched piece of data that is used by the processor before it gets evicted from the cache can avoid a costly cache miss in the future. Often, an entire cacheline is prefetched by one such prefetch action. However, prefetching data into the cache that will not be used by the processor before its eviction has two kinds of costs. One is that the prefetched data will occupy important resources, such as bandwidth to the DRAM chips, bandwidth on the wires connecting the DRAM to processors and the space in the cache that would have been used to hold other data. There is also a cost associated with prefetch attempts of data that already is present in the cache.

These costs include the extra hardware resources used, or the extra energy used, for the extra cache lookup required to determine that the data targeted by the prefetch already resides in the cache. In the case of software prefetching, the costs could also come from the overhead of executing the extra prefetch instruction and the negative effects on power and performance caused by the code expansion caused by the insertion of the software prefetch instructions. Furthermore, the overhead required by the analysis used to find where to insert software prefetches, as well as their prefetch type, may be prohibitive for practical usage.

Accordingly, it would be desirable to provide systems and methods that avoid the afore-described problems and drawbacks, and which provide an effective strategy for inserting software prefetches resulting in a good cost/benefit tradeoff.

### SUMMARY

These and other drawbacks associated with conventional prefetching techniques are addressed by various embodiments which analyze a baseline program or application in order to determine which types of software prefetching techniques to insert into the baseline application.

According to an embodiment, a method for modifying an application to perform software prefetching of data and/or instructions from a memory device, includes the steps of: capturing behavioral information from an execution of the application; performing at least one of (a) a stride access analysis and (b) an irregular access analysis, based on at least some of the captured behavioral information for at least some of the instructions in the application; identifying target instructions in the application, based on the performing step, whose execution can benefit from at least one of (a) an identified strided prefetching technique and (b) an identified prefetching technique associated with irregular access patterns; and inserting the identified prefetching techniques into the application.

According to another embodiment, a method for determining prefetching instructions to insert for corresponding target instructions in a software application includes the steps of identifying a register used to calculate a data address for a target instruction, searching the software application to find a load instruction associated with the identified register; and evaluating the load instruction to determine at least one prefetching instruction to insert into the software application.

According to another embodiment, a method for inserting prefetch instructions into a software application includes the steps of identifying an original trace of instructions in the software application, generating a copy of the original trace of instructions at a new location within the software application, modifying the copy of the original trace to ensure that branches in the original trace branch to an appropriate location, and inserting the prefetch instructions into the software application within the copy of the original trace.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 shows an example of a computer architecture in which a baseline program can be run and aspects of data access latency;

FIG. 2 illustrates modification of a baseline application to include prefetching techniques according to an embodiment; and

FIGS. 3-10 are flowcharts depicting various methods for identifying and/or inserting prefetching techniques into a baseline program according to embodiments.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to the terminology and structure of shallow shear-wave splitting analysis using receiver functions. However, the embodiments to be discussed next are not limited to these configurations, but may be extended to other arrangements as discussed later.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Embodiments described herein address these, and other, challenges by providing, for example, for efficient insertion of software prefetches. Embodiments provide, among other things, techniques for capturing information about the application behavior, techniques for identifying per-instruction cache behavior and identifying memory instructions that miss in the caches, techniques for identifying instructions with strided access patterns, techniques for identifying instructions with irregular access patterns, techniques for finding appropriate placement-conscious instructions, techniques for estimating the cost/benefit tradeoff of inserting a certain software prefetch, efficient techniques for handling the code modification needed for the insertions, and/or techniques for lowering (and in some cases eliminating) the application runtime overhead for executing inserted software prefetches, techniques for lowering the overhead for information about the application behavior, and techniques for representing prefetch activity to improve its applicability.

Thus, the various embodiments described herein provide for, among other things, an effective and accurate strategy for inserting software prefetches into a software program or application. Prior to discussing these embodiments in detail, some context is provided as an overview. The embodiments to be described below can be implemented using a suitable processor, set of processors, computer or computer system which is configured to implement one or more of the methods or algorithms described herein. Purely as an illustration, computing system 100, shown in FIG. 2, is a generic representation of all such devices which can be configured to perform some or all of the method steps/techniques described below.

As an input, the computing system 100 receives the baseline application 102 to be modified, i.e., the software application which does not yet have prefetching instructions added thereto (or at least not the prefetching instructions to be added by these embodiments). The computing system 100 modifies the baseline application to insert prefetching instructions, as will be described below, to generate a modified application 104. Note that the computing system 100 can represent, for example, either a software production system, such that the software prefetching is added to the application as part of the software production prior to distribution to end users, or the computing system 100 can represent an end users system such that the software prefetching is added to the application after its purchase by or distribution to an end user. Moreover, some or all of the steps described for the various embodiments may be performed before, during or after compilation of the application or at runtime of the application. Alternatively the steps could be distributed between compilation and runtime in any desired manner, and likewise could be distributed between the production process of the application and the client/end user's usage of the application.

With this in mind, and as an overview of the various embodiments, techniques for inserting prefetches into an application can include one or more of the steps illustrated in the flow diagram of FIG. 3. Each of the steps will initially be described briefly below, and then subsequently will be explored in more depth following this overview.

At step 300, behavioral information is captured based on one or more executions of the baseline application 102. The captured information can be used to analyze the application behavior, as well as the behavior of each individual memory instruction in one or more of the remaining steps. At step 302, the cache behavior is modeled based on the behavior information, i.e., the expected behavior of a given or target cache hierarchy is modeled using the execution information captured at step 300. The modeled cache behavior can be used to analyze the application behavior, as well as the behavior of each individual memory Instruction in one or more of the remaining steps. Step 302 may be optional in some cases, e.g., if the information captured at step 300 does not need any extra modeling.

At step 304, instructions that may benefit from prefetching, referred to herein as prefetch candidates, are identified. According to some embodiments, this step is optional as one could perform step 306 and/or 308 against all of the instructions in the baseline application 102. A stride access analysis is performed for each prefetch candidate to identify instructions that could benefit from strided prefetching techniques at step 306 and an appropriate pending prefetch method for each identified instruction can be recorded. Additionally, or alternatively, at step 308, an irregular access analysis is performed for each prefetch candidate to identify instructions that may benefit from prefetching techniques targeting irregular access patterns and an appropriate pending prefetch method can be recorded for each. As indicated above, according to some embodiments only step 306 may be performed, only step 308 may be performed or both steps 306 and 308 may be performed.

At step 310, a cost/benefit analysis is performed for each pending prefetch method that was recorded at step 306 and/or 308 to determine if the execution of the baseline application 102 would benefit from its insertion and, if so, marking each such prefetching method for subsequent insertion into the baseline application 102. At step 312, the selected prefetch methods are inserted into the baseline application 102's source code, assembler instructions or binary representation, or in any other type of application representation.

### Capturing Application Behavior Information (Step 302)

With this overview in hand, each of the steps described above with respect to FIG. 3 will now be described in more detail, beginning with capturing behavior information associated with the execution of the baseline application at step 302. Inserting software prefetches requires a careful and accurate analysis of program behavior in order to find the right places to insert the prefetches, as well as deciding what data to prefetch and how early it should be prefetched in order to arrive at the cache early enough to avoid latency issues.

This task can be aided by capturing and analyzing behavior Information about the application 102. The behavior information suggested by this embodiment can be captured with a very low runtime overhead, which is of great importance for its applicability. This behavior information can, for example, be captured by a few recording primitives, each recording primitive having some defined function and which also may record some information about the behavior. The recorded information may then be used by any of the later steps in FIG. 3 or later during the current step. Such recording primitives can include one or more of the following.

A first such primitive is an event counter, which is a method to count how many times a specific event has occurred during execution of the application. The different events counted by such an event counter can include, but are not limited to, the number of instructions, the number of instructions of a specific type, the number of memory references, the number of references of a specific type, the amount of time, the number of unique data object accessed from a specific point in time (referred to as stack distance) or any other measurable unit. It could also count how many times a dynamic event has occurred.

In one embodiment, an event counter may be implemented as hardware counters. In a different embodiment the application can be dynamically or statically instrumented to count some specific events. Examples of instrumenting tools that may perform such an instrumentation include, but are not limited to, the PIN tool by Intel and the DynInstr tool by the University of Wisconsin. Any other counter present in the software of the application itself, or in the hardware it is running on, may also be used as an event counter. The value of an event counter may get recorded by other recording primitives.

Another recording primitive which can be used to capture an application's behavior is referred to herein as a selection mechanism, which is a method to select one or many instructions in the stream of instructions executed by the application. This selection may be done using different strategies, including but not limited to, random selection using some sample rate or biased selection based on some specific property. The sample rate may further be specified by a distribution function, such as a mathematical distribution function. Some distribution functions which can be used in this context include, but are not limited to, exponential and normalized distributions. The selection mechanism may be biased towards selecting certain kinds of instructions, including but not limited to, memory instructions, instructions of a specific type, instructions in a specific address range, memory instructions with a high data cache miss ratio or memory instruction with a high miss rate. Data that may get recorded about each selected instruction include, but are not limited to, the identity of the selected instruction and the identity of the data it accesses. In one embodiment, each such identity is the address of the instruction and the data, respectively.

In one embodiment the selection mechanism may be implemented by programming an event counter to cause an interrupt for the instruction to be selected. In another embodiment, the selection mechanism is performed by a timer interrupt that causes the execution to stop on the selected instruction. In some implementations, the selection mechanism may use one specific means to halt the execution some time before the selected instruction and use some other means to precisely target the selected instruction. In another embodiment, the selection mechanism is implemented by static or dynamic rewriting techniques. In yet another embodiment, the selection mechanism is implemented based on trap-events generated by the operating system or the hardware.

Another recording primitive which can be used to record application execution behavior is referred to herein as data triggering. Data triggering is initiated to make the next access to a piece of data, or a data region, setup to start a triggering action. The next time that piece of data, or that data region, is accessed, the specified trigger action is initiated. The instruction accessing such data that causes such trigger action is called a triggering instruction. The trigger action can take the form of, but is not limited to, halting or trapping the execution, recording some specific information about the execution or the processor state, and recording some event counter, including but not limited to the number of instructions, the number of memory references or some other time measurement. Other data that may get recorded as a triggering action include, but are not limited to, the identity of the triggering instruction and the identity of the data accesses by the triggering instruction.

Yet another recording primitive which can be used to record application execution behavior according to an embodiment is referred to as instruction triggering. Instruction triggering is initiated to make the next access to an instruction, or a region of instructions, setup to start a triggering action. The next time that instruction, or that region of instructions, is executed, the specified trigger action is initiated. The instruction accessing such data that causes such trigger action is called a triggering instruction. The trigger action can take the form of, but is not limited to, halting or trapping the execution, recording some specific information about the execution or the processor state, and recording some event counter, including but not limited to the number of instructions, the number of memory references or some other time measurement. Other data that may get recorded as a triggering action include, but are not limited to, the identity of the triggering instruction and the identity of the data accesses by the triggering instruction.

Yet another recording primitive which can be used to record application execution behavior according to an embodiment is called microtracing. As the name implies, microtracing is a primitive used to collect a microtrace (MT). A microtrace is a recording of a selected sequence of instructions executed during a period of the execution. The duration for such a period may range from a few instructions to many thousand instructions. Examples of information that may be recorded for a microtrace include, but are not limited to, the sequence of identities of every instruction executed during the period, the sequence of identities of every basic block during the period, the sequence of identities of the target instruction for every taken branch during the period and the sequence on instructions of a specific type executed during that period. In one embodiment, a microtrace is recorded by selecting a first instruction and recording its identity, after which the next instruction is executed using a so-called single-stepping technique and its identity is recorded. This procedure is repeated until the entire microtrace has been recorded. In one embodiment, the recording of a microtrace is ended when an instruction already recorded in the microtrace is reached.

One skilled in the art will appreciate that the afore-described recording primitives can be implemented using a multitude of techniques, including but not limited to, simulation, static instrumentation, dynamic instrumentation and hardware implementation or combinations of these techniques. Similarly, those skilled in the art will appreciate how these concepts can be implemented, e.g., during static analysis of a program.

For example, and according to one aspect of these embodiments, the selection mechanism randomly selects memory instructions based on a predetermined sample rate and/or distribution. Each such selected instruction may start a data triggering and/or an instruction triggering activity. According to one aspect of the embodiment using the afore-described triggering activity feature, when each such triggering feature starts, a start value of one, or many, event counters are recorded. When the triggering for each corresponding triggering instruction occurs, a trigger value of the same respective event counters is recorded. In one embodiment, the difference between each pair of named trigger value and start value is recorded.

As another example regarding how to implement the behavior monitoring step 302 using the afore-described techniques, the selection mechanism randomly selects memory reference instructions based on some specified, possibly variable, sample rate and some specified sample distribution, for example exponential distribution. For each such selected instruction, the address of the selected instruction, referred to herein as the monitored instruction address (MIA), is recorded and also the address of the data it accesses is recorded, which is referred to as the monitored data address (MDA). Furthermore the value of one, or many, event counters are recorded, which is referred to herein as the monitored counter value (MCV). A data triggering is set up to trigger the next instruction which accesses data in a data address region that corresponds to a cacheline containing an MDA. The data triggering activity is defined to record the address of the triggering instruction, referred to herein as the triggering instruction address (TIA), to record the address of the data it accesses, referred to herein as the triggering data address (TDA) and record the value of the same named event counters, referred to herein as the triggering counter value (TCV). Examples of event counters that can be used include, but are not limited to, a counter counting memory references, a counter counting instructions and a counter measuring time. Subtracting the MCV from the TCV gives a triggering reuse distance (TRD) for data reuse captured by this schema. The TRD may be recorded and can be associated with the MIA, and can also be associated with the TIA. Subtracting the MIA from the DTA gives the data address stride (DAS) between the MIA instruction and the TIA instruction. The DAS may be recorded and can be associated with MIA, and can also be associated with the TIA.

In one embodiment, an instruction trigger is also initiated for the named selected instruction. The instruction triggering is defined to trigger for the next execution of the selected instruction identified by the named MIA. Its triggering activity is defined to record the address of the data named next execution of the instruction accesses, referred to as the recurring data address (RDA) and to record the value of the same named event counters, referred to as the recurring counter value (RCV). Subtracting the MDA from the RDA gives the recurring address stride (RAS) for the MIA instruction. The RAS may be recorded and may be associated with the MIA instruction. Subtracting the MCV from the RCV gives the recurring reuse distance (RRD) for the MIA instruction. The RRD may be recorded and may be associated with the MIA instruction.

The above described method of recording the RAS and the RRD may be for a selected MIA, for which both TRD and DAS (and other associated Recorded information) is recorded. Alternatively, the RAS/RRD may be recorded for a selected MIA, for which DAS/TRD is not recorded. It is also possible to record DAS/TRD for a selected MIA for which RAS/RRD is not recorded. For clarity, this list includes some of the recorded information elements discussed above, one, some or all of which may be captured as part of the performance of step 302: Monitored Instruction Address (MIA), Monitored Counter Value (MCV), Triggering Instruction Address (TIA), Triggering Data Address (TDA), Triggering Counter Value (TCV), Triggering Reuse Distance (TRD), Data Address Stride (DAS), Recurring Data Address (RDA), Recurring Counter Value (RCV), Recurring Address Stride (RAS), and Recurring Reuse Distance (RRD).

According to one aspect of the embodiments, the recorded information retrieved in association with a selected instruction MIA can include, but is not limited to: MIA, MDA, MVC, TIA, TDA, TRD, DAS, RDA, RCV, RAS and RRD. This kind of information can be recorded each time a specific instruction is selected or executed in the baseline application 102. For each specific instruction, a histogram for each of the recorded values TRD, DAS, RAS, RRD can be created for situations when it was identified as the MIA instruction.

According to another aspect of the embodiment the kind of recorded information retrieved in association with a triggering instruction address (TIA) instruction can include, but is not limited to: MDA, MVC, TIA, TDA, TRD, DAS, RDA, RCV. This kind of information can be recorded each time a specific instruction performs a data triggering as described above. For each specific instruction, a histogram for each of the recorded values TRD, DAS can be created for situations when it was identified as the TIA instruction.

For the performance of step 302 using microtraces, microtraces may be recorded with separate selection mechanisms, or may be associated with an instruction with the MIA or TIA role in a selection. In one embodiment, a microtrace may be recorded in such a way that its last recorded instruction becomes the MIA of the recording of MDA, MVC, TIA, TDA, TRD, DAS, RDA or RCV information. If two microtraces contain the same instruction, or the same sequence of instructions, they could be composed to form a larger microtrace. For example, if microtrace A contains instruction {a, b, c, d} and microtrace B contains instructions {c, d, e, f}, the larger microtrace {a, b, c, d, e, f} could be recorded. This could be continued recursively to construct even larger microtraces.

It should be noted that most of the recorded information discussed so far are of an architecturally-independent nature. For example, they do not indicate how often a cache hit or a cache miss occurs in the computer architecture where the baseline application 102 is executed.

However, those skilled in the art will appreciate that architecturally dependent information, such as hardware counter information which records actual cache misses at all cache levels, could also be directly recorded. Moreover, such skilled artisans would also understand that information similar to, for example, TRD, DAS, RAS and RRD could also be deduced directly from a sufficiently long microtrace.

### Modeling Cache Behavior (Step 304)

Having now described various techniques which can be used to perform step 302 relating to the collection of the baseline application 102's behavior during execution, the discussion now proceeds to how that captured behavior information can be used to model the expected cache behavior of a given cache hierarchy when that cache hierarchy is used to execute the baseline application 102. It will thus be appreciated that step 304 can be performed differently for different computer architectures, i.e., it takes into account the type of computer architecture for which the modified application 104 is intended to be optimized.

For example, a cache model could be used to assess the cache hit and cache miss behavior in the caches that each individual instruction would experience when running on a specific architecture. Such a cache model should be able to tell how likely it is that the data accessed be a specific instruction will result in a cache hit, referred to as its hit ratio. In one embodiment, an event counter can be used directly to model caches. For example, an event counter counting cache misses which are read before and after the selected instructions are executed can be used to determine how many times each selected instruction hit and miss in the cache and can thus estimate its hit ratio to be the hit count divided by the sum of the hits and misses.

In another embodiment, an architecture simulator can be used to model the cache behavior and determine the hit ratio. Such a cache model may be driven by address traces generated by static or dynamic instrumentation or may be driven by the execution of the application in a processor simulator.

In another embodiment, such a cache model can be implemented as a statistical model such as StatCache proposed by Berg et al. in the article entitled “.Statcache: A probabilistic approach to efficient and accurate data locality analysis”, published in the Proceedings of the International Symposium on Performance Analysis of Systems and Software, 2004, the disclosure of which is incorporated here by reference. StatCache takes the set of recorded TRD value as its input and estimates the miss rate for a fully associative cache with a random replacement strategy.

The Berg et al. article proposes the following equation for estimating the overall miss rate of an application, for which n distinct TRD values, ranging from TRD(0) to TRD(n) have been recorded during a duration of the execution of an application:

M*n=Σₖ₌₀ⁿmiss_function(M*TRD(k)) [1]

where miss_function for fully associative caches with random replacement is: miss_function(x)=1−(1/L)^{x}; and L denotes the number of cachelines in a cache. M is the unknown miss ratio, which can be solved numerically by iterative methods to estimate the average miss ratio for that duration of the execution. It is interesting to note that the miss ratio for any cache size can be determined by solving the equation for different values of L (number of cache lines).

In one embodiment, the method proposed by Berg et al. is extended to also estimate the individual miss ratio that a specific instruction may experience in a cache with random replacement. Assuming the duration of an application execution for which the n distinct TRD values used above, ranging from TRD(0) to TRD(n), have been recorded, and that for j of these recorded TRDs, denoted TRDX(0) to TRDX(j) a specific instruction X has been recorded as the TIA. Then, the estimated miss ratio for each of the instruction recorded TRDX values can be calculated as: miss_function (M*TRDX(k)) and the estimated average miss ratio for instruction X can be estimated by:

$$Miss\_Ratio \_X = [ {\sum }_{k = 0}^{j} miss\_function ( M * TRDX ( k ) ) ] \frac{1}{j} \qquad [ 2 ]$$

Berg et al. further proposes a different model using the same input data as the random replacement model, but instead modeling a cache with LRU replacement. Here, the TRDs recorded during the duration of the application are used to form a probability function TRD_larger_than(x) for that duration, which estimates the likelihood that one TRD is larger than the value x. In one embodiment, the method proposed by Berg et al. is complemented to also estimate the individual miss ratio that a specific instruction may experience in a cache with LRU replacement. Assume that the duration of an application execution for which the n distinct TRD values used above, ranging from TRD(0) to TRD(n), have been recorded and that the TRD_larger_than(k) function is formed by determining the number of the named n TRDs are larger than the value k. Then, the estimated number of unique cachelines accessed in between the selected instruction and the triggering instruction used to form a specific TRD value, referred to as TRDX, can be calculated as:

Number_unique_Cachelines(TRDX)=Σₖ₌₁^{TRD}XTRD_larger_than(k) [3]

If the number of unique cachelines is larger than the number of cachelines in the modeled cache, then the triggering instruction of the TRDX access is determined to be a cache miss.
Identifying Instructions that are Prefetch Candidates (Step 304)

Having modeled the cache behavior for a given architecture(s) when executing the baseline application 102, the next step in the method embodiment of FIG. 3 is to identify instructions within the baseline application 102 that may benefit from being prefetched, which are referred to herein as prefetch candidates, using the information obtained from step 300 and/or 302. Some non-limiting examples regarding how step 304 can be implemented will now be described.

For example, the cache model generated as described above can identify instructions in the baseline application 102 that may benefit from prefetching. In one embodiment, this set of prefetch candidate instructions could include all instructions that have a miss ratio above a certain threshold. This threshold could be chosen based on the maximum gain provided from software prefetching compared with the minimum cost of inserting one software prefetch instruction. For example, if removing one cache miss could potentially avoid the processor waiting a maximum of 100 cycles (i.e., the maximum gain) and the minimum cost for executing one software prefetch instruction is one cycle, then this translates into a threshold of 1%, since 100 prefetch instructions would be executed for each cache miss removed. Thus the threshold for identifying an instruction as a prefetch candidate in step 304 according to one embodiment can be set as:

Threshold=(MaximumGain_Minimum_Cost)/Minimum_Cost [4]

This is a fast way to determine which instructions need to be examined further to find corresponding software prefetch insertion strategies. In other embodiments, the threshold used for prefetch candidate identification can be determined by practical experiments using micro benchmarks or the baseline application 102. In another embodiment, the threshold is defined to be a specific miss ratio and memory instructions having a miss ration above the threshold are identified as prefetch candidates.

### Performing Stride Analysis (Step 306)

For each prefetch candidate, i.e., either a subset of the instructions in the baseline application 102, e.g., selected as described above in step 304 or, alternatively, all of the instructions in the baseline application 102, the method of FIG. 3 can then evaluate whether that prefetch candidate is suitable for prefetching using a particular prefetching technique. In this step 306, the particular prefetching technique being evaluated is strided access however, as described below, embodiments can alternatively or additionally evaluate the prefetch candidate instructions for other types of prefetching, e.g., based on irregular access patterns.

For step 306, however, the system evaluates each prefetch candidate to determine whether it is part of a strided access pattern with a specific stride using the recorded information associated with that instruction. Herein, as part of this evaluation, each such studied instruction is referred to as an examined instruction and the data address which the studied instruction accesses is referred to as address A. Each examined instruction that is determined to be part of a strided access pattern causes a pending prefetch method to be recorded. For example, if such a strided access pattern with a specific stride is identified for the examined instruction, then an appropriate pending prefetch method to be recorded for that examined instruction could, for example, be inserting a prefetch instruction for address (A+Stride) in conjunction with the examined Instruction accessing the address A.

In one embodiment, a reuse histogram is composed by all the recorded RRD values for which the examined instruction is identified as the triggering instruction. If one dominant stride exists in the reuse histogram, then the examined instruction is determined to be part of a strided access pattern with the dominant RRD value as its stride.

In one embodiment, a dominant RRD range can also be detected, by identifying a dominant range of strides, rather than only a specific stride. One such range could, for example, be strides ranging from one byte up to the cacheline size of the target architecture. If a dominant stride range is detected, prefetches using a specific stride could be considered, for example for the dominant stride range from one byte up to the cacheline size, a prefetch stride equal the cacheline size could be considered. Herein, the usage of the phrase “dominant stride” may mean either a single dominant stride, a range of dominant strides or both.

For each dominant stride, or dominant stride range, a stride ratio can be estimated as the fraction of the examined instruction's RRDs that has the dominant stride, or dominant stride range. This is an indication of the fraction of cache misses experienced by the examined instruction that potentially could be removed using a prefetching based on the dominant stride. In one embodiment, an examined instruction is determined to have a dominant stride, or stride range, if the stride ratio of that instruction is above a certain threshold.

Often, prefetching data one iteration (i.e. one stride) ahead of its usage will not bring the prefetched data into the cache early enough to turn the next access of the strided access pattern into a cache hit. Consider a small tight loop where a specific instruction has a high miss ratio and where the cachelines have to be brought in from a slow DRAM with more than 100 cycle latency. This is a scenario where prefetching the data for the next iteration of the loop will not get the data into the cache early enough for covering the miss that would occur in the next iteration. The number of iterations ahead that the data needs to be prefetched to avoid a cache miss is referred to as its prefetch distance (PD).

Here is an example of such a loop after an appropriate prefetch has been inserted:

```
for (i =0, i < HUGE, i=i+STEP) {
  ...
  sum+=a[i];
  ...
  prefetch(&a[i+(PD*STEP)]);
  }
```

The behavioral information recorded about the baseline application 102 in step 300 can also be used to determine an appropriate prefetch distance. For example, recorded recurring reuse distance (RRD), or recurrence for short, values from counters counting time records the time spent in a loop, but the overhead incurred from the recording primitives may obscure such recorded values. Recorded RRD values from counters counting the number of instructions will provide the number of instructions between occurrences of the examined instruction. Assuming a specific execution rate, for example assuming that a processor executes two instructions per cycle, also known as its cycle per instruction (CPI) value, will enable the system to estimate the number of cycles per iteration. Knowing the instruction frequency, i.e., the clock rate, will enable the system to calculate the time for each iteration.

However, the CPI for a specific loop is typically not known and, even if it was, that CPI value is for the loop without the prefetch instruction(s) that the system of FIG. 1 may want to insert. Instead, the system could either assume a reasonable CPI value based on common knowledge, select a desirable CPI that the system sets for optimized execution of the loop, use the lowest possible CPI for the target architecture or estimate the lowest possible CPI for the loop under consideration considering given a specific target architecture, or in other words, select an appropriate CPI value to be used to estimate an appropriate prefetch distance for the examined instruction.

Given the selected CPI and other known information, the prefetch distance can be calculated by the equation:

PD=Miss_Latency*Clockrate*Miss_Ratio/(Target_CPI*Recurrence) [5]

where the Miss_Ratio is the miss ratio for the dominant stride accesses of the examined instruction, and the Recurrence is the RRD as measured in number of instructions for the dominant stride accesses of the targeted instruction. If the recorded data cannot single out the RRD and Miss_Ratio for the dominant stride accesses of the targeted instruction, then their values can be estimated by picking the dominant RRD and the Miss_Ratio for the dominant reuse distance. In one embodiment, the Miss_Latency is determined by the latency of the cache level that provides a majority of the data. This cache level can be determined for the examined instruction using the cache modeling techniques described above. It should be noted that equation (5) also holds for other types of prefetching, such as indirect access patterns.

With this basis in mind, the flowchart of FIG. 4 illustrates steps which can be performed to identify pending prefetch methods for strided accesses, i.e., it is one embodiment for performing step 306 of the general method of FIG. 3. However those skilled in the art will appreciate that other techniques can be used to perform step 306.

Therein, at step 400, a target instruction with a dominant stride is identified, i.e., as described above, and its address is calculated. Then, at step 402, the miss ratio and dominant recurrence of the target instruction are identified or determined as described above. An appropriate prefetch distance is estimated using the miss ratio and dominant recurrence values, e.g., by calculating equation (5) above, at step 404. A prefetch instruction is formed at step 406 with an address calculation that is identical to the address calculation of the target instruction plus the value calculated by multiplying the estimated prefetch distance and named dominant stride. The new prefetch instruction is recorded as a pending prefetch method for the examined instruction at step 408. This pending prefetch method may then be inserted into the baseline application 102 later at step 312 if it survives the (optional) cost/benefit analysis of insertion at step 310, as will be described in more detail below. In one embodiment, the pending strided prefetch method may be recorded by recording some of its determined properties, including, but not limited to the identity of the examined instruction, its dominant stride, its prefetch distance and its prefetch ratio.

### Perform Irregular Access Analysis (Step 308)

Prefetch candidates that do not have strided access patterns may have an irregular access pattern of some sort. Accordingly, for each prefetch candidate, systems and methods according to these embodiments can examine if the prefetch candidate is part of an irregular access pattern for which the system can propose a prefetch method at step 308. In short, according to this embodiment, for each examined instruction that is determined to be part of an irregular access pattern for which there is a detected prefetch method, that detected prefetch method is recorded as a pending prefetch method for potential later insertion into the baseline application 102.

In one embodiment, prefetch candidates are determined to have an irregular access pattern if their stride histogram shows a wide variety of strides with no dominant stride value. An example of a method for determining the lack of dominant stride values includes, but is not limited to, an analysis that determines the prefetch candidate to have no specific stride value that represents more than some fraction of all its accesses. A threshold value used for such an analysis could, for example, be a percentage number. In one embodiment, only prefetch candidates with irregular access patterns are considered as examined instructions for irregular access analysis. In this context, accesses that do not have stride-based access patterns are referred to as irregular access patterns and their stride is referred to as a random stride.

There may be a number of different types of irregular access patterns. Three such types are described herein which are associated with indirect accesses, pointer chasing and nested objects.

To better understand how pending prefetch methods associated with indirect accesses are identified according to these embodiments, an example will be helpful. Consider the following loop for a huge vector a[ ] and an even larger sparse data structure s[ ]:

```
for (i =0, i < HUGE, i++) {
  sum+=s[a[i]];
  ... }
```

which can be translated into pseudo-ASM as:

| Line | COMMENT | MISS RATE | STRIDE |
|---|---|---|---|
| 0: LOOP:SUB R1, R1, #4 | // i++ | | |
| 1: BEZ R1, #JUMP | // last time? | | |
| 2: LD R2, (R1) | // R2 = a[i] | 12.5% | 4 |
| 3: LD R3, (R2) | // R3 = s[a[i]] | 99.7% | RANDOM |
| 4: ADD R4, R4, R3 | // sum += . . . | | |
| . . . | | | |
| 5: BR #LOOP | | | |
| JUMP: | | | |

In the pseudo-code above, line 3 is a memory load of data from the address identified by the value stored in register R2, which has been identified to have a high miss rate and with a random stride. Thus, the strided prefetching techniques described previously do not apply for this access. Since the content of R2 dictates the next memory access at line 3, it is useful to determine if R2's next value can be predicted to enable prefetching also for this type of access pattern. Searching backward along a likely execution path for the instruction where R2 was last written, the instruction in line 2 can be identified. Line 2 is the writer of R2 (memory load of data from the address identified by the value stored in Register R1 into R2). Since line 2 is identified to be a load with a constant stride (here stride=4) its future action can be anticipated and a new load instruction can be inserted that loads the value PD iterations ahead of time. PD can be determined using the methods described in Equation (5) above and can be used to calculate the address of a prefetch instruction that will prefetch the data needed by the instruction at line 3. For example, one possible solution is to insert two new instructions just before the instruction at line 2 as:

| | |
|---|---|
| 1.5:LD R2, 4*PD(R1) | //gets a[i+PD]. Will also “prefetch a[i+PD]”) |
| 1.7:prefetch.nta (R2) | //Prefetching s[a[i]] |

It should be noted that the new instruction 1.5 has a regular strided access pattern and that the strided prefetch methods described earlier could be applied to this instruction if the vector a[ ] is too large to fit in a cache.

In architectures with register renaming, including many so-called out-of-order processors, the WAW/WAR data dependencies between the new instructions and line 2 will have no negative effect on the instruction issuing rate in the processor pipeline. For other processors, a more careful live-analysis will be needed to find another free register to use instead of R2.

If line 2 has a high likelihood of cache misses (such as 12.5% in this example), the strided access pattern prefetch analysis described earlier will have identified it as a pending prefetch method with a specific stride and prefetch distance. In such a case, its prefetch distance may need to be increased to allow for the non-strided prefetch to get started on-time. This could for example be done by calculating the required PD separately for line 2 and line 3 respectively, and make the new prefetch distance used for line 2 be equal to the sum of the two.

Moreover, note that the new line 1.5 above may access elements up to an index of a[HUGE+PD]. This may create illegal memory accesses causing exceptions to happen, since the vector a[ ] may be declared to have a size up to a[HUGE]. Care must be taken to avoid the application crashing when that happens, for example by informing the trap handler that instruction 1.5 is harmless and that register R2 can be allowed to contain any value after its completion, or by using a special harmless load instruction that may return garbage data but may not crash the application. Such a harmless instruction is for example the speculative load instruction included in the EPIC architecture. Yet another way to make the load instruction harmless could be to guard it with an extra “if” statement. Care should also be taken in the cost/benefit analysis step 310 described below to take the extra overhead from the extra workarounds needed by harmful instructions into consideration.

Based on the foregoing, the flowchart of FIG. 5 depicts a method embodiment for identifying pending prefetch methods for indirect accesses. Therein, a target instruction with a high miss rate and an irregular access pattern (e.g., with a random stride) is identified at step 500. Then, the register used to calculate the data address for the target instruction is identified at step 502. A search is performed, at step 504, backwards from the target instruction along a likely execution path until a load instruction updating the register identified in step 502 is found, which is referred to herein as the updating instruction. In one embodiment, the likely execution path is determined to either be in the same basic block as the target instruction, along the likely execution path based on runtime sampling, along an execution path based on static analysis or along the most common execution path as recorded by a commonly recorded microtrace from step 302.

If the updating load instruction is detected to be part of a strided access pattern, at step 506, then its stride is recorded and it is determined that the target instruction is of an irregular type called indirect access, otherwise it is determined to not be an indirect access and the method of FIG. 5 ends or, alternatively, continues based on the assumption that the access type is a pointer access type or a nested object access type, as will be described below. Assuming that the load instruction is identified as an indirect access type of irregular access, then the miss ratio and the dominant recurrence for the target instruction are identified at step 508 as previously discussed. The appropriate prefetch distance PD is estimated using the miss ratio and recurrence values, e.g., as shown above in equation (5), at step 510.

The address calculation of the load instruction which updates the register identified in step 502 is identified, and a new load instruction is identified to have its address calculation (step 512) defined to be the address calculation of the updating load instruction added to the value of PD multiplied by the stride of the updating instruction. A new prefetch instruction is identified to have the same address calculation as the target instruction, and then both the prefetch instruction and the new load instruction are recorded as a pending prefetch method for the target instruction at step 514. In one embodiment, a pending irregular prefetch may be recorded by recording some of its determined properties, including, but not limited to, the identity of the target Instruction, its irregular type, its miss ratio, its new load instruction and its new prefetch instruction.

This pending prefetch method may then be inserted into the baseline application 102 later at step 312 if it survives the (optional) cost/benefit analysis of insertion at step 310, as will be described in more detail below. Those skilled in the art will appreciate that some of the steps 500-512 may be omitted or altered to fit a particular computer architecture or instruction set for which the baseline application 102 is being modified.

Those skilled in the art can understand how the above-described method can be extended recursively to handle access indirection, for example the type of indirection shown in this example:

```
for (i =0, i < HUGE, i++) {
  sum+=s[b[a[i]]];
  ... }
```

which can be translated into pseudo-ASM as:

| Line | //COMMENT | miss rate | STRIDE |
|---|---|---|---|
| 0: LOOP:SUB R1, R1, #4 | // i++ | | |
| 1: BEZ R1, #JUMP | // last time? | | |
| 2: LD R2, (R1) | // R2 = a[i] | 12.5% | 4 |
| 3: LD R3, (R2) | // R3 = b[a[i]] | 99.7% | RANDOM |
| 4: LD R4, (R3) | // R4 = s[b[a[i]]] | 99.7% | RANDOM |
| 5: ADD R4, R4, R3 | // sum += . . . | | |
| . . . | | | |
| 6: BR #LOOP | | | |
| JUMP: | | | |

Using the methodology of FIG. 5 to identify, and later insert, prefetching instructions, into the above-code example, would result in the insertion of three new instructions just before instruction 2, e.g.,:

| | |
|---|---|
| 1.5: LD R2, 4*PD(R1) | //gets a[i+PD]. |
| 1.6: LD R3, (R2) | //gets b[ a[i+PD]] |
| 1.7: prefetch.nta (R3) | //Prefetching s[b[a[i]]] |

It should be noted that the new instruction 1.5 has a regular strided access pattern and that the strided prefetch methods described earlier could be applied to this instruction if the vector a[ ] is too large to fit in a cache. It should also noted that the new instruction 1.6 has an indirect access pattern and that the indirect prefetch methods described here could be applied to it if the data structure b[ ] is too large to fit in a cache.

In addition to the indirect access type described above, another type of irregular access pattern is known as “pointer chasing”. Pointer-chasing is a well-known access pattern commonly used in software applications. A pointer value is used to access a next object, which (among other possible information) may contain a pointer to a data object in the chain. The execution of each traversal in the pointer-chasing code is limited by the memory access time. The application needs to obtain the pointer to the new object before the access to the next object can get started. To illustrate pointer chasing, consider the following pointer-chasing code:

```
struct node {val1, val2, ... ,next} *ptr;
while (...) {
  ptr->next = malloc(node);
  ptr = ptr->next;
  ptr->val1 = 0 ; ptr->val2 = 0; ... }
while (ptr->next){
  sum1 += ptr->val1;
  sum2 += ptr->val2;
  ptr = ptr->next }
```

The last “while loop” translated into pseudo-ASM can be expressed as:

| Line | //Comment | miss rate | STRIDE |
|---|---|---|---|
| 0: LOOP:BEZ R3 #JUMP | | | |
| 1: LD R1 (R3) | // R1=val1 | 100% | RANDOM |
| 2: ADD R7, R7, R1 | //sum1 += . . . | | |
| 3: LD R2 4(R3) | //R2 = val2 | 4% | RANDOM |
| 4: ADD R8, R8, R1 | //sum2 += . . . | | |
| 5: LD R3 42(R3) | //ptr = . . . | 34% | RANDOM |
| 6: BR #LOOP | | | |

Referring to the pseudo-code above, line 1 is memory load relative to R3 with a high miss rate and a random stride. Searching backward along a likely execution path the system will find instruction 5 (from the previous iteration) loading a new pointer value to R3. Note that the code uses the old value of R3 to calculate the address of the data loaded from memory and note the displacement value 42, which indicates the displacement of the pointer in the data object relative to the pointer address. As soon as R3 has been loaded with the pointer value pointing to the next data object the pointer value stored in the next data object can be accessed by adding the displacement value of 42 to the value in register R3, denoted as 42(R3), and initiating a prefetch to that address. This could, for example, be done by inserting the following new instructions 0.5 and 0.6 between instruction 0 and instruction 1 in the above pseudo-code example.

| | |
|---|---|
| 0.5:LD R1, 42(R3) | // Pre-computes ptr to next chain object (duplicates |
| | line 5) |
| 0.6:prefetch (R1) | //Prefetching the chain object of the next iteration |

These new instructions will start prefetching the next data object pointed to by the new object pointed to by R3. Out-of-order execution will make sure that the new memory prefetch is sent out as soon as the pointer to the previous data object is available in R1. It should be noted that instruction 0.5 could be a harmful instruction unless the test performed by instruction 0 handles all harmful cases.

Based on the foregoing, a method embodiment for inserting prefetches for instructions which can be characterized as being of the pointer access type is illustrated in FIG. 6. Therein, at step 600, a target instruction with a high miss rate and an irregular access pattern is identified. The register used to calculate the data address for the target instruction is identified, referred to here as the pointer register, at step 602.

A search is performed backwards from the target instruction along a likely execution path until a load instruction updating the pointer register is identified, at step 604, referred to here as the updating instruction. As in the previous embodiment, determining likely execution paths for evaluation in step 604 can, for example, be performed by either looking in the same basic block of instructions as the target instruction, looking along the likely execution path based on runtime sampling, along an execution path based on static analysis or along the most common execution path as recorded by a commonly recorded microtrace from step 302.

If the updating instruction identified in step 604 is using the pointer register to calculate the data address for its memory access, it is determined that the target instruction is of an irregular type called pointer access type at step 606, otherwise it is determined to not be a pointer access type access and the method ends or, alternatively, continues based on the assumption that the access type is instead a nested object access type. This latter aspect is described below with respect to FIG. 7.

At step 608, a new load operation is formed with the same address calculation as the updating instruction but loading to a register which is different from the pointer register, which is to be inserted after the updating instruction in the execution order of the baseline application 102. Additionally, a prefetch instruction loading from the address identified by the different register is formed at step 610. Both the prefetch instruction and the new load instruction are recorded as a pending prefetch method for the target Instruction at step 612. In one embodiment, a pending irregular prefetch of the pointer access type may be recorded by recording some of its determined properties, including, but not limited to the identity of the identity of the target Instruction, its irregular type, its miss ratio, its new load instruction and its new prefetch instruction.

This pending prefetch method may then be inserted into the baseline application 102 later at step 312 if it survives the (optional) cost/benefit analysis of insertion at step 310, as will be described in more detail below. Those skilled in the art will appreciate that some of the steps 600-612 may be omitted or altered to fit a particular computer architecture or instruction set for which the baseline application 102 is being modified.

In one embodiment, all of the instructions calculating a data address relative to the pointer register are inspected along a likely execution path and their respective displacements are recorded. In this embodiment, two prefetch instructions are generated, i.e., one with the largest recorded displacement and one with the smallest recorded displacement. One example of this would be to add yet another prefetch instruction in the above example right after instruction 0.7 for example, as:

| | |
|---|---|
| 0.8:prefetch LD(R1) | // LD is the largest recorded displacement |

If the difference between the largest and smallest displacement is larger than the cacheline size, then additional prefetch instructions can be generated to fetch cachelines between the largest and smallest displacement.

A variant on the foregoing pointer access type of irregular access pattern occurs when pointer access type instructions in the baseline application 102 are nested in the code and relate to one another. Accordingly, other embodiments provide the capability to adjust the inserted prefetches to deal with this situation. To understand this case, consider the following piece of code, representing a combination of pointer chasing and nested data objects:

```
struct node {obj1, obj2, ... ,next} *ptr;
while (...) {
  ptr->next = malloc(node);
ptr = ptr->next;
  ptr->obj1 = malloc(obj);
  ptr->obj2 = malloc(obj);
  ptr->obj1->val = ... ;
  ... }
while (ptr->next){
  sum1 += ptr->obj1->val;
  sum2 += ptr->obj2->val;
  ptr = ptr->next}
```

The last “while loop” translated into pseudo-ASM can be expressed as:

| Line | //Comment | miss rate | STRIDE |
|---|---|---|---|
| 0: LOOP:BEZ R3 #JUMP | | | |
| 1: LD R1 (R3) | // R1=obj1 | 100% | RANDOM |
| 2: LD R5 12(R1) | // R5 = obj1->val | 100% | RANDOM |
| 3: ADD R7, R7, R5 | //sum1 += . . . | | |
| 4: LD R2 4(R3) | //R2 = obj2 | 0% | RANDOM |
| 5: LD R6 12(R2) | // R6 = obj2->val | 100% | RANDOM |
| 6: ADD R8, R8, R6 | //sum2 += . . . | | |
| 7: LD R3 42(R3) | //ptr = . . . | 0% | RANDOM |
| 8: BR #LOOP | | | |

The pointer chasing analysis described above would identify the same prefetching as in the previous example to reduce cache misses associated with Line 1 and would thus suggest inserting the same new instructions 0.5 and 0.6. However, in this pseudo-code there is now the additional load instruction in Line 2, i.e., a nested instruction, which was not present in the pseudo-code described above for the pointer chasing analysis. The high miss ratio and random stride for Line 2 will also make it a prefetch candidate for irregular access patterns. Its address calculation is relative to the value stored in R1 which will prompt the system 100 to search backwards along a likely execution path to find where R1 was last updated. This search will indicate Line 1 as being the updating instruction, which instruction has already been identified to be part of a pointer chasing access pattern. Accordingly, the system 100 now knows that the proposed new instruction 0.5 will pre-compute the pointer to new chain object accessed in the next iteration and store its value in R1.

To address this issue, the system 100 will replace the prefetch instruction proposed for line 0.6 with a computation to pre-compute the pointer to obj1 of the next iteration (this action will also “prefetch” the next chain object) after which the val of obj1 for the next iteration is prefetched (line 0.7). The high miss ratio and random stride for Line 5 will likewise indicate to the algorithm of this embodiment that it is desirable to pre-compute the pointer to obj2 of the next iteration and prefetch its value val in line 0.8 and 0.9. Thus, according to this embodiment, the prefetch instructions to be recorded for potential insertion into the last pseudo-code example will be

| | |
|---|---|
| 0.5:LD R1, 42(R3) | // Pre-computes ptr to the next chain object of line7 |
| 0.6 LD R5, (R1) | //pre-compute ptr to obj1 of next iteration |
| 0.7Prefetch 12(R5) | //prefetch val of obj1 |
| 0.8LD R5, 4(R1) | // pre-compute ptr to obj2 of next iteration |
| 0.9prefetch 12(R5) | //prefetch val of obj2 |

It should be noted that instructions 0.5, 0.6 and 0.8 could be harmful instructions unless the test performed by instruction 0 handles all harmful cases.

Based on the foregoing example, a method embodiment for handling nested objects can be expressed as illustrated in the flowchart of FIG. 7. Therein, at step 700, a target instruction with a high miss rate and an irregular access pattern is identified. The register used to calculate the data address for the target instruction is identified, referred to here as the pointer register, at step 702.

A search is performed backwards from the target instruction along a likely execution path until a load instruction updating the pointer register is identified, at step 704, referred to here as the updating instruction. As in the previous embodiment, determining likely execution paths for evaluation in step 704 can, for example, be performed by either looking in the same basic block of instructions as the target instruction, looking along the likely execution path based on runtime sampling, along an execution path based on static analysis or along the most common execution path as recorded by a commonly recorded microtrace from step 302.

If the updating load instruction identified in step 704 has previously itself been determined to be a pointer access type, then it is determined that the target instruction (which occurs in the execution sequence of the baseline application 102 after the updating load instruction) is a nested object access type instruction at step 706, otherwise the method ends. Assuming that the target instruction is determined to be a nested object access type instruction at step 706, then the value anticipated to be loaded into the pointer register (i.e., by pre-computing that value in conjunction with the calculation of the next chain object for the pointer access type instruction relative to which this target instruction is nested) is loaded into a different register at step 708. To distinguish it from the pointer register, this different register is here referred to as a second register.

At step 710, a prefetch instruction which loads from the address identified by the value stored in the second register is recorded or stored as a pending prefetch method. This pending prefetch method may then be inserted into the baseline application 102 later at step 312 if it survives the (optional) cost/benefit analysis of insertion at step 310, as will be described in more detail below. Those skilled in the art will appreciate that some of the steps 700-710 may be omitted or altered to fit a particular computer architecture or instruction set for which the baseline application 102 is being modified.

### Perform Cost/Benefit Analysis (Step 310)

As described above, various techniques have been discussed to identify and then record or store pending prefetching methods. These are called “pending” prefetch methods since they may, or may not, actually be inserted into the baseline application 102. According to one embodiment, all of the pending prefetch methods can be inserted into the baseline application, i.e., step 310 is optional. According to another embodiment, a subset of the recorded or stored pending prefetch methods is actually inserted into the baseline application 102. The subset can be selected in any desired manner, but should recognize the tradeoff that while the execution of the baseline application could clearly benefit if the software prefetch instructions to be inserted lower the miss ratio in the data cache, inserting software prefetches also comes with several costs. For example, executing the extra prefetch instructions uses pipeline resources, which would slow down other instructions and consume extra energy. Furthermore, the extra prefetch instructions will make the binary code larger which may increase the instruction cache miss ratio.

Thus, according to some embodiments a cost/benefit analysis can be performed at step 310 in order to decide if a specific pending prefetch method should indeed be inserted into the application. This can be done by estimating the cost for executing the instruction compared with the gain each executed instruction on average will result in. This cost/benefit analysis could, for example, be performed by taking into account the modeled success rate of the prefetching compared with the modeled cost for executing the extra prefetch instructions.

In one embodiment, the benefit from a specific pending prefetch which has been recorded by one of the previous steps in FIG. 3 can be estimated by taking into account some of its recorded properties, including, but not limited to, one or more of: miss ratio, stride ratio, prefetch distance, miss latency and hit latency. The exact formula for the prefetch benefit is highly dependent on the computer system implementation. For one specific, yet purely illustrative, implementation the upper limit for the prefetch benefit can be calculated as:

Upper_limit_benefit=Miss_Ratio*(Miss_Latency−Hit_Latency) [6]

which assumes that all misses experienced by the targeted instruction can be removed and that the architecture cannot hide any of the latency for accessing the cache memories.

Other architectures may have some ability to hide some amount of cache latency, here referred to as latency hiding. For those architectures, the upper limit for the prefetch benefit can, for example, be calculated as:

Upper_limit_benefit=Miss_Ratio*(Miss_Latency−Latency_Hiding) [7]

which assumes that all misses experienced by the targeted instruction can be removed and that the architecture cannot hide any of the latency for accessing caches.

For some prefetch types, a more specific prefetch benefit can be calculated. This can for example be done for strided prefetches, by also taking the stride ratio and prefetch distance into account. The stride ratio can be used to estimate the average stride length, i.e., the average length of accesses with the dominant stride. The stride length can be calculated as:

Stride Length=Stride_Ratio/(1−Stride Ratio) [8]

If the stride length multiplied by the stride is much shorter than the cache line size of the cache where the prefetched data are brought in, the real benefit from the prefetching will be smaller than the upper limit benefit. For example, a stride of 4 bytes and a stride ratio of 75% resulting in a stride length of 3, indicates that the corresponding stream of accesses will only cover 12 bytes of data on average. Assuming a cache line size of 64 bytes, only a small fraction of those streams will cross the cache line boundaries and benefit from the prefetching. One way to partially overcome this is to calculate a stride miss ratio for the prefetch candidate, where only the recorded RRD for the accesses with the dominant stride is used for calculating the miss ratio.

The foregoing focuses on techniques for calculating or determining a benefit associated with inserting each of the recorded prefetching techniques into the baseline application 102. The cost of inserting each recorded prefetch technique may be estimated by, for example, empirical experiment on the target architecture or can be based on the cost for using the resources required by the method. The difference, or ratio, between the estimated benefit and cost can then be determined and, e.g., compared with a threshold or margin to determine whether to select the recorded prefetch technique for insertion. The threshold could for example be set to a value such that the estimated benefit is larger than the estimated cost. It could also be adjusted to favor a more or less aggressive prefetch policy.

Inserting Selected Pending Prefetch Methods into Baseline Application (312)

Once the prefetch methods are identified and, optionally, filtered for selection, the method of FIG. 3 proceeds on to insert the pending prefetch methods and instructions into the baseline application. The techniques described in this embodiment show one way to perform such instruction insertion, e.g., a technique for rewriting a pseudo-assembler to insert prefetch instructions. However, those skilled in the art will realize that such insertions could be performed in many different ways, including but not limited to, a change at the source-code level, incorporating the optimization inside a compiler, performing an extra compilation, performing the optimization on some level of representation of the program including but not limited to some intermediate-level representation, assembler-level representation or on the binary itself. It would also be possible to perform the optimization at runtime, including but not limited to, changing the binary representation of the program, incorporating the optimizations in a managed-code environment or performing the optimization in a virtual machine environment.

Modifying the binary code associated with the baseline application 102, hereafter referred to as a rewriting, without enough information from the compiler could be a hazardous task. Inserting one new instruction will displace some other instruction's addresses. Without information about the jump labels it is hard to determine if such a displacement can be done correctly, since some branch instruction may assume that an instruction resides in a specific address.

One possible work-around is to add a branch trampoline, where one instruction is replaced by a branch to a completely new location, such that this new location contains the replaced instruction and in addition also the new instructions required for the optimization and that the instruction at this new location ends with a branch instruction that jumps back to the instruction immediately following the replaced instruction's original place in the code. However, such a scheme could introduce unnecessary overhead caused by many new branch instructions. Also, it requires that the replaced instruction is of the same length, or longer than, the branch instruction replacing it.

A more efficient and safe way to do this is to perform the rewriting for a set of instructions that are known to often be executed in a sequence. Such a sequence of instructions is referred to herein as the original trace. Such an original trace may contain loops. According to an embodiment, rewriting based on original trace can be performed as in the flow chart of FIG. 8.

Therein, at step 800, an original trace of instructions is identified. This step can be performed, for example, by identifying a frequently recorded microtrace. A new copy of the original trace of instruction is created in a new location at step 802. This new trace of instructions is referred to as the new trace. Initially, the new trace is modified, at step 804, to make all of its branches that used to branch to destination instructions in the original trace instead branch to the corresponding destination instructions of the new trace. This modification is then further refined to account for different types of branches in step 808.

The new trace is modified, at step 806, to make all of its branches that used to branch to destination instructions outside the original trace using program counter (PC) relative branching branch to the same destination instructions. In this context, branches which use so-called PC relative branches base the branch-to address on the program counter value (which may be that of the current instruction or the next instruction). For example, a PC-relative branch may specify the branch as “go to the instruction at address PC+42”. If a branch in the new trace is PC-relative with a destination outside of the new trace, its PC value (i.e., its address) is different from the old trace so the displacement (42 in the example) will have to be modified at this step 806. However, if the branch outside the original trace is not PC-relative and, for example, uses a value stored in a register as the destination address, there is no need to change it at this point in the process.

The new trace is also modified, at step 808, to make all of its non-PC relative branches that used to branch to destination instructions inside the original trace branch to the corresponding destination instructions inside the new trace. The new trace is then modified to perform the desired optimizations, i.e., by inserting the pending prefetch methods which have been selected for insertion into the baseline application 102, at step 810. At least one instruction in the original trace is modified to instead perform a branch to the location in the new trace holding the copy of the instruction which has been modified to include this new branch, as indicated by step 812. Those skilled in the art will realize that so-called PC relative accesses to data also will have to be modified in the new trace.

In one implementation emphasizing register usage, a register save operation can be performed for some registers in conjunction with the new branch to the new trace and corresponding register restores for named registers performed for all branches in the new trace branching to locations outside of the new trace. That way, the saved registers can be used freely in the new trace without a global register live analysis.

There are a couple of advantages with this approach. One is that the cost for the branch to the new trace can be amortized over many more instructions. This is especially true if the original trace contains loops that are frequently executed. Another advantage is that the new trace can spill/fill of registers at the one branch from the original code to the new trace and on all the exit points of the new trace. In this way the new trace may utilize many registers in the optimizations.

Having described the method of FIG. 3 for analyzing a software application in order to determine how and where to insert prefetch instructions into a baseline program 102, a few additional, related techniques will now be discussed. For example, the prefetch strategy outlined in these embodiments may execute a considerable amount of SW prefetches that will find the requested cacheline already in the L1 cache. These prefetches are referred to herein as useless prefetches. Executing these useless instructions comes at a cost of slowing down the application and consuming energy.

Even though the prefetch strategy as a whole may save energy due to benefits from useful prefetches, it is still desirable that the energy consumed by useless prefetches is kept at a minimum. Many useless prefetches are associated with prefetch streams with strides smaller than a cacheline, resulting in one useful and several useless prefetches to each cacheline. The most common strides by far are short positive strides. For example, an access to the byte address A may be followed by accesses to byte address A+4, A+8 and so on.

A more efficient prefetch instructions would make the L1 cache lookup be conditional on the value of the least significant bits (LSB) of the address to be prefetched and make sure that the cache lookup is done a fewer number of times for each cacheline. One example of such a new prefetch instruction is a software prefetch instruction that only performs a lookup in the L1 cache if the LSB bits are of a specific value. Assuming the example above, address bits 0 and 1 will always have the same value for the access stream. Assuming a cacheline of size 64 bytes, the four address bits 2 through 5 will change their values in a sequential manner, such that their combined value for the four bits will assume all the sixteen possible values from 0 to 15 while accessing the same Cacheline. Hence, if we know that our software prefetches will be to a stream of stride+4, we could make the L1 lookup conditional on the value of address bits 2 through 5 and only perform the lookup if the combined value of these were equal to a specific value. That way the L1 lookup will only be performed once per cacheline instead of 16 times.

The generalized functionality of such a conditional prefetch instruction could be defined with the pseudo code:

COND_PREFETCH(mask_bits, match_v, addr): if ( (addr &
mask_bits) == match_v)
LOOKUP(address)

where mask_bits is a bit vector having the bit corresponding to an address bit that is significant for the comparison set to the value 1, otherwise 0; match_v contains the value of the significant bits required for a lookup; and, addr is the byte address to be prefetched. In the above example, mask_bits would have the value 111100 and match_v could have the value 000000.

In one embodiment, a new conditional prefetch instruction is provided with a functionality such that a cache lookup is only performed if some of the bits of the address defining the cacheline to prefetch from memory corresponds to a specific value is added to an instruction set. Examples of such prefetch instructions would be prefetch0, that only performs a cache lookup if the some identified bits of the memory address are equal to the value 0. Other prefetch instructions associated with other values that 0 could also be possible,

In another embodiment, a new prefetch instruction is added that only will get executed with some predefined probability. For example, one such prefetch instruction may get executed with a probability of 25%, referred to as its execution ratio.

Such a probability prefetch instruction could be defined as:

PROB_PREF(Execution_Ratio,addr): if (RAND(0,1)>Execution_Ratio)PREFETCH(addr)

Such a probability prefetch instruction with an Execution Ratio of 25% will get executed at least one out 16 iterations with a probability of 99%. Still, it will only need to be executed 25% as often as normal prefetch instructions in the above example.

Yet another proposal for more efficient prefetch instructions is a combined memory/prefetch operation. Considering an instruction Prefetch-Load-Positive (PLD+) that load a value from a defined address into a defined register, but also prefetches Cacheline with the next higher address. Other examples of a similar nature include Prefetch_Load_Negative, with its prefetch activity instead targeting the cacheline with the next lower address, or similar instructions combining Store operations and prefetch operations.

Useless prefetches only require a lookup in the cache tag array, which only cost a fraction of a normal tag operation (15% of energy) and also has a shorter latency than the full cache lookup. The prefetch may be interleaved between two adjacent LD accesses with no extra overhead for prefetch cache hits.

Other enhanced prefetch instructions can also be considered for insertion into the baseline application 102. For example, some prefetch methods require more than just a single prefetch instruction to be inserted. This is, for example, the case for the pointer chasing and indirect accesses described earlier.

In this context, consider that prefetching pointer chasing accesses adds the following instructions:

| | |
|---|---|
| A:LD R1, 42(R3) | // Pre-computes ptr to next chain object (duplicate |
| | line7) |
| B: prefetch (R1) | //Prefetching the chain object of the next iteration |

Consider also that prefetching indirect accesses adds the following instructions:

| | |
|---|---|
| C:LD R2, 4*PD(R3) | //gets a[i+PD]. Will also “prefetch a[i+PD]”) |
| D:prefetch.nta (R2) | //Prefetching s[a[i]] |

There are many other examples where two or more instructions are added as a prefetch method. Many of these examples include one or many load instructions (instruction A and C respectively in the two examples above) that load some address value into a register. That register value will only be used by the following prefetch instruction (i.e., instructions B and D, respectively, in the two examples above).

Based on the foregoing, and according to other embodiments, it may be desirable to also use prefetch preparation instructions for the following reasons. Prefetch instruction is often implemented as a non-faulting instruction, i.e., if they cause and error such as an illegal access to memory, that error will silently be dropped. That avoids the situation where the prefetch action otherwise could crash an execution while performing speculative work that is not strictly needed by the execution. However, there are situations where also the extra inserted load instructions (in the above example instructions A and C) could also cause fatal errors, such as when instruction C fetches a value outside of the bounds of the vector a[ ] and thus may access a page for which the program does not have access rights. Such an error of a load instruction is not silent and would crash the execution, even though the load instruction is part of the prefetching method added and should be regarded as a speculative execution.

Accordingly, a prefetch preparation instruction type, i.e., an instruction that performs its normal prefetch function, but will not case a fatal error to crash the program, is described her. For example, the load instructions A and C in the two examples above should be of a prefetch preparation type. An error caused by a prefetch preparation type instruction should be silent and not cause a crash of the program. It is envisioned that many different existing instruction could be implemented as such prefetch preparation instructions, not just load instructions as in the two examples. Moreover, it is also envisioned that prefetch methods where more than one instruction is present should be of prefetch preparation type.

In one embodiment, a prefetch preparation instruction would mark its destination register with an error value when it is detected that the instruction has caused an error. A following instruction that uses a source register containing such an error value would not perform its operation and would get dropped. In one embodiment, a following instruction that uses a source register containing such an error value would mark its destination to hold an error value.

In the examples above instructions A and C would both need to store their calculated value in a register, and would therefore use some register resources. Furthermore, these instructions need to be completed before their following instructions (B and C, respectively) can be performed. This may cause some processor pipelines, such as in-order pipelines or pipelines with limited out-of-order capabilities, to stall. In some implementations, a prefetch instruction with unresolved data dependence may get dropped. This may cause instructions B and D in the two examples above to never perform their prefetch task.

Thus according to another embodiment, a new type of fused prefetch instruction is proposed that performs the work of several normal instructions in a non-faulty way. One such instruction could be a LD-prefetch instruction that, for example, performs the task of both instruction A and B in the above example. One possible semantic of such an instruction could be

E:LD-prefetch 42(R3) //Prefetch data at address identified by value
in R3 plus the constant 42

This instruction would add the value 42 to the value currently stored in R3 and use the results as an address from which it would perform a prefetch. When compared with the instructions A and B, note that the usage of a register R1 to link the load and the prefetch no longer is needed. This can have several implications. First, it will not consume any register resources other than R3. Second, it can avoid extra pipeline stalls due to the fact that there was a data dependence between A and B carried by the register R1. Lastly, there is no destination register associated with the new fused instruction, which means that the fused instruction can be sent to the memory system and no longer need to occupy resources associated with the pipeline.

The prefetching of indirect accesses would be implemented as a single fused prefetch instruction F instead of the two instruction C and D, e.g.,:

F:LD-prefetch 4*PD(R3) //Prefetch from addr. identified by value in
R3 plus the constant 4*PD

In one embodiment, the fused prefetch instruction may be a non-faulting instruction and silently dropped on an error. In one embodiment, the fused prefetch instruction is implemented entirely in the memory system and will not occupy any resources. In one embodiment, a fused prefetch instruction may not occupy resources in a reorder buffer of an out-of-order processor. In one embodiment, a fused prefetch instruction may perform the functionality of several prefetch instructions. This includes instructions that may prefetch two adjacent cachelines given some conditions.

An example of one such instruction is “LD-2prefetch 47(R3), 56”, that would calculate a base address as the value stored in register R3 plus the constant 47; perform a prefetch of the data stored on the base address; and perform a prefetch for the data stored on the base address plus the constant 56. In one embodiment, the second prefetch action would only be carried out if it is determined that the two prefetches are for different cachelines.

The technique of caching exists in many other settings within, as well as outside, a computer system. An example of such usages are the virtual memory system caching data from a very slow high-capacity storage, such as a disk or FLASH memories, into a faster and smaller high-capacity memory that could be implemented using dynamic RAM. Other examples of caching in a computer system include, but are not limited to, disk caching, web caching and name caching. The organizations and caching mechanism of such caches may vary from the caches discussed above, such as their size of a set, their implementation of sets and associativity. Regardless of the implementation of the caching mechanism itself, the embodiments outlined in this disclosure are still applicable for prefetching data into the various caching schemes.

The methods described above are also capable of further generalization, examples of which are provide in the flow charts of FIGS. 9 and 10, but which generalizations are not limited thereto. FIG. 9, for example, illustrates a method for modifying an application to perform software prefetching of data and/or instructions from a memory device. At step 900, behavioral information is captured from an execution of the baseline application. At step 902, at least one of (a) a stride access analysis and (b) an irregular access analysis, are performed as described above based on at least some of the captured behavioral information for at least some of the instructions in the application. One or more target instructions in the application are identified, at step 904 and based on the performing step, whose execution can benefit from at least one of (a) an identified strided prefetching technique and (b) an identified prefetching technique associated with irregular access patterns; and the identified prefetching techniques are inserted into the application at step 906.

According to another embodiment a method for determining prefetching instructions to insert for corresponding target instructions in a software application is illustrated in FIG. 10. Therein, at step 1000, a register used to calculate a data address for a target instruction is identified. At step 1002, the software application is searched to find a load instruction associated with the identified register. The load instruction is evaluated, at step 1004, to determine at least one prefetching instruction to insert into the software application.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a non-transitory computer-readable storage medium for execution by a general purpose computer or a processor. Each of the methods described above, and in the claims below, may also therefore be implemented as systems having one or more processors which are configured to perform each of the method steps, and as a non-transitory computer readable medium which contains program instructions which, when executed on or more processors, performs the method steps.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for modifying an application to perform software prefetching of data and/or instructions from a memory device, comprising the steps of:
capturing behavioral information from an execution of the application;
performing at least one of (a) a stride access analysis and (b) an irregular access analysis, based on at least some of the captured behavioral information for at least some of the instructions in the application;
identifying target instructions in the application, based on the performing step, whose execution can benefit from at least one of (a) an identified strided prefetching technique and (b) an identified prefetching technique associated with irregular access patterns; and
inserting the identified prefetching techniques into the application.

2. The method of claim 1, further comprising:
analyzing each identified prefetching technique associated with a respective identified instruction to select which of the identified prefetching techniques to insert into the application based on a cost/benefit analysis; and
inserting the selected, identified prefetching techniques into the application.

3. The method of claim 2, wherein the step of analyzing further comprises:
determining an estimated improvement in a cache miss ratio, or a cache hit ratio, associated with inserting the identified prefetching technique into the application;
determining an estimated cost in terms of additional resources required to be used associated with inserting the identified prefetching technique into the application;
selecting the identified prefetching technique for insertion into the application if the estimated improvement is greater than the estimated cost by a predetermined margin or threshold.

4. The method of claim 1, wherein the behavioral information includes at least one of data reuse information and instruction reuse information.

5. The method of claim 1, wherein the behavioral information includes one or more microtraces.

6. The method of claim 1, wherein the prefetching technique is inserted as a fused prefetching instruction which performs an operation of multiple instructions.

7. The method of claim 6, wherein the step of performing an irregular access analysis is performed using the one or more microtraces.

8. The method of claim 1, wherein the step of modeling cache behavior further comprises:
estimating a cache hit and/or cache miss ratio for selected instructions in said application for each of a plurality of caches.

9. The method of claim 1, further comprising:
modeling cache behavior associated with execution of the application based on the captured behavioral information.

10. A method for determining prefetching instructions to insert for corresponding target instructions in a software application, the method comprising:
identifying a register used to calculate a data address for a target instruction;
searching the software application to find a load instruction associated with the identified register; and
evaluating the load instruction to determine at least one prefetching instruction to insert into the software application.

11. The method of claim 10, wherein the step of searching further comprises:
determining a likely execution path to find the load instruction.

12. The method of claim 10, wherein the step of evaluating further comprises:
determining whether the load instruction is detected to be part of a strided access pattern;
if so, determining a miss ratio and the dominant recurrence for the target instruction; and
estimating a prefetch distance associated with the target instruction using the miss ratio and recurrence value;
forming a load instruction which has an address calculation of the load instruction added to the value of prefetch distance multiplied by a stride of the load instruction.

13. The method of claim 12, wherein the step of evaluating further comprises:
identifying a prefetch instruction having a same address calculation as the target instruction; and
storing both the prefetch instruction and the load instruction for insertion into the software application.

14. The method of claim 10, wherein the step of evaluating further comprises:
determining if the load instruction is using a pointer register to calculate a data address for its memory access;
if so, forming a new load operation with a same address calculation as the load instruction but which loads to a register which is different from the pointer register, which new load operation is to be inserted after the load instruction in an execution order of the software application.

15. The method of claim 14, further comprising:
generating a prefetch instruction which loads from an address identified by the different register; and
storing both the prefetch instruction and the load instruction for insertion into the software application.

16. The method of claim 14, further comprising:
if the load instruction has previously been determined to be a pointer access type instruction, then identify the target instruction as a nested object access; and
loading a value which is anticipated to be loaded into the pointer register into a different register.

17. The method of claim 16, further comprising:
storing a prefetch instruction which loads from an address identified by the value stored in the different register.

18. The method of claim 10, further comprising:
identifying, as the target instruction, an instruction having a cache miss rate above a predetermined threshold and having an irregular access pattern.

19. A method for inserting prefetch instructions into a software application, the method comprising:
identifying an original trace of instructions in the software application;
generating a copy of the original trace of instructions at a new location within the software application;
modifying the copy of the original trace to ensure that branches in the original trace branch to an appropriate location; and
inserting the prefetch instructions into the software application within the copy of the original trace.

20. The method of claim 19, wherein the step of modifying further comprises modifying the copy of the original trace to make all of its branches that used to branch to destination instructions in the original trace instead branch to the corresponding destination instructions of the new trace.

21. The method of claim 20, wherein the step of modifying further comprises:
modifying the copy to make all of its branches that used to branch to destination instructions outside the original trace using program counter (PC) relative branching branch to the same destination instructions.

22. The method of claim 21, wherein the step of modifying further comprises:
modifying the copy to make all of its non-PC relative branches that used to branch to destination instructions inside the original trace branch to the corresponding destination instructions inside the new trace.

23. The method of claim 19, wherein the step of identifying an original trace of instructions in the software application further comprises:
identifying, as the original trace, a frequently recorded microtrace.
